(19) United States
(12) Patent Application Publication
(10) Pub. No.: US 2022/0067846 A1
(43) Pub. Date: Mar. 3, 2022

(54) COMPUTER-ASSISTED AGRICULTURAL ADMINISTRATION SYSTEM

(71) Applicant: 365FarmNet Group KGaA mbH & Co. KG, Harsewinkel (DE)

(72) Inventor: Marten Grundmann, Berlin (DE)

(73) Assignee: 365FarmNet Group KGaA mbH & Co. KG, Harsewinkel (DE)

(21) Appl. No.: 17/465,220

(22) Filed: Sep. 2, 2021

(30) Foreign Application Priority Data
Sep. 3, 2020 (DE) 102020123019.2

(51) Int. Cl. G06Q 50/02; G06Q 10/06; G06Q 40/08; G05B 13/02

(52) U.S. Cl. CPC G06Q 50/02; G05B 13/0265; G06Q 40/08; G06Q 10/06315

(57) ABSTRACT

A computer-assisted agricultural administration system for planning, monitoring and administering work and operating data in the execution and performance of agricultural processes is disclosed. The administration system includes a server platform with at least one database and at least one interface for bidirectional communication with at least one external data source. The database saves in a cyclically updatable manner a database relevant to planning, monitoring and administering agricultural processes. The machine assistance system concludes at least one insurance policy automatically via the server platform using an input/output unit of the machine assistance system depending on an input of at least one specific designation. The machine assistance system determines the probability of occurrence of a loss event to be insured and to select a suitable insurance policy considering the least one entered specific designation, the saved database, and the received actuarial information provided by the external data source.

### CROSS REFERENCE TO RELATED APPLICATION

This application claims priority under 35 U.S.C. § 119 to German Patent Application No. DE 102020123019.2 filed Sep. 3, 2020, the entire disclosure of which is hereby incorporated by reference herein.

### TECHNICAL FIELD

The present invention relates to a computer-assisted agricultural administration system and a computer-implemented method for planning, monitoring and administering work and operation data for executing and performing agricultural processes.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Computer-assisted agricultural administration systems are used for planning, monitoring and administering work and operating data in the execution and performance of agricultural processes with the object of being able to optimally use resources such as agricultural work machines, agricultural work assemblies, operating fluids, seed, etc., and to optimize yields through harmonized use and resource planning. The administration system includes a server platform with at least one database, and at least one interface for bidirectional communication with at least one external data source. The database is configured to save data relevant or pertinent to planning, monitoring and administering agricultural processes in a cyclically updatable matter.

### DESCRIPTION OF THE DRAWINGS

The present application is further described in the detailed description which follows, in reference to the noted drawings by way of non-limiting examples of exemplary implementation, in which like reference numerals represent similar parts throughout the several views of the drawings, and wherein:

FIG. 1 illustrates a schematic representation of an administration system with a schematic and exemplary overview of a business premises.

FIGS. 2a-2b illustrate a schematic representation of a schematic and exemplary representation of two fields at different processing times.

FIG. 3 illustrates a schematic representation of a flowchart of a method for operating an administration system.

### DETAILED DESCRIPTION

As discussed in the background, computer-assisted agricultural administration systems are used for planning, monitoring and administering work and operating data in the execution and performance of agricultural processes. The term “planning, monitoring and administering work and operating data in the execution and performance of agricultural processes” is to be interpreted broadly. This may include all measures and devices that are needed to perform agricultural processes. An agricultural process may be individually performed by an agricultural device (e.g., an agricultural work machine and/or an agricultural work assembly). Alternatively, the agricultural process may comprise multiple individual processes, which may be performed by a single agricultural device at different times, or by multiple agricultural devices. Example agricultural processes including, but are not limited to any one, any combination, or all of planting of, tending to, or harvesting of crops. In this regards, the processes may be several processes harmonized with each other in terms of time and/or location that are administered and coordinated by the administration system. The number of agricultural devices participating in the one or more processes may vary.

In the context of planning for the execution and performance of agricultural processes using the administration system, it may be necessary to guard against risks that, for example, may result from uncontrollable natural events or other external influences, such as involving third parties. For example, a crop failure may occur from a drought, hail, accident, pest infestation or wild animal damage. To guard against such events, it is possible to conclude, create, or consummate insurance policies that are generally very comprehensive in terms of location and time (e.g., include a policy that covers an entire farm and have a term of the entire year).

However, it may be a problem to design and develop a computer-assisted agricultural administration system that is more tailored to the practical requirements in the agricultural sector.

In one or some embodiments, a computer-assisted agricultural administration system is disclosed for planning, monitoring and administering work and operating data for executing and performing agricultural processes. The administration system includes a server platform with at least one database and at least one interface for bidirectional communication with at least one external data source. The at least one database is configured to save in a cyclically updatable manner a database (e.g., data) relevant to any one, any combination, or all of: planning; monitoring; and administering agricultural processes. In one or some embodiments, a machine assistance system is configured to automatically manage at least one insurance policy at one or more stages of the life of the insurance policy. In particular, the machine assistance system may be configured to automatically perform any one, any combination, or all of: conclude, consummate, create or issue at least one insurance policy via the server platform using an input/output unit of the machine assistance system depending on an input of at least one specific designation of a unit to be insured; automatically obtain information in order to evaluate whether one or more conditions have been met under the concluded, consummated, created or issued insurance policy; and/or automatically determine whether to perform an action under the concluded, consummated, created or issued insurance policy (e.g., responsive to determining to issue a payout, determine to notify the insurance carrier that the concluded, consummated, created or issued insurance policy is subject to a payment, a payout, and/or issue (such as cause the electronic transfer for payment) the payout under the concluded, consummated, created or issued insurance policy). Responsive to any one, any combination, or all of these actions, a communication (such as a real-time communication) may be sent indicating the performance of the respective action (e.g., in response to issuance of the insurance policy, transmitting in real time by the machine assistance system to another device, such as the server, indicating the issuance of the insurance policy and one or more of its policy terms; in response to determining to issue a payout under the insurance policy, transmitting in real time indicating the payout under the insurance policy and/or causing the payout under the insurance policy). The machine assistance system is configured to determine the probability of occurrence of a loss event to be insured and to select a suitable insurance policy (e.g., selecting one or more terms, from a plurality of available terms) taking into account any one, any combination, or all of the at least one entered specific designation, the saved data, and received actuarial information that are provided by the at least one external data source. In this way, the machine assistance system may automatically specifically guard against or consider singular risks when performing agricultural processes. The at least one specific designation of at least one unit to be ensured specifically includes the envisioned insurance coverage. A unit to be ensured within the context of the present disclosure may comprise a device or an event. The probability of occurrence of a loss event (with the loss event the subject of the insurance policy and determined by the machine assistance system) may be used as a trigger for automatically concluding, consummating, creating or issuing an insurance policy in advance. The farmer may thereby be relieved of the administrative effort or burden of the mechanics of this stage in the life of the insurance policy. In particular, the farmer may merely specifically designate a unit to be insured for one or more aspects of the policy to be concluded, consummated, created, or issued (e.g., responsive to designating the unit to be insured, one or more other aspects of the insurance policy, such as the scope of the policy (such as the conditions under which to issue a payout pursuant to the insurance policy) may be automatically concluded, determined, created, or decided, and the insurance policy (and ensuing coverage) may be established. In this way, the farmer's input may comprise a trigger by which to perform one or more actions.

In one or some embodiments, the at least one specific designation may be selected from any one, any combination, or all of: time-related designation(s); location-related designation(s); machine-specific designation(s); plant-specific designation(s); or loss-type-specific designation(s). The system, responsive to the farmer's input as to the specific designation(s) may accordingly establish the scope (e.g., selecting one or more terms) of the automatically-concluded, automatically-created, or automatically-issued insurance policy so that insurance coverage is tailored to the farmer's needs.

In so doing, a time designation may be treated by the system as a limit of the policy term to a period of a loss event to be expected that is determined based on actuarial information. The term of the policy may therefore be limited to the period within which an occurrence of a loss event is deemed probable. This holds true, in particular, for an occurrence of just one singular natural event and/or for just a seasonal use of agricultural devices (e.g., agricultural work machines and/or agricultural work assemblies, etc.). The system may restrict comprehensive insurance coverage of devices designed as agricultural work machines and/or agricultural work assemblies depending on the seasonal usefulness to brief periods within a year (e.g., to subpart(s) of a respective year, such as a single season in the respective year). Accordingly, for example, the insurance policy may act as a safeguard due to losses of earnings caused by technical downtimes of agricultural work machines and/or agricultural work assemblies. Alternatively, or in addition, the insurance policy may cover (e.g., for a limited period) accidents or losses due to driving agricultural work machines and/or work assemblies in public street traffic. In particular, in order to tailor the insurance policy, the administration system may access the time period(s) within or at which the agricultural work machines and/or agricultural work assemblies are moved outside of a business premises, such as on public streets, in order for example for the agricultural work machines and/or agricultural work assemblies to reach a field to be processed. In one or some embodiments, the determination as to the time period(s) within or at which the agricultural work machines and/or agricultural work assemblies are moved outside of a business premises may be based on sensor devices, such as a GPS receiver, on one or both of the agricultural work machines and/or agricultural work assemblies. Within these time periods, there is a risk of an accident, such as involving a third party. In this regard, the administrative system, in generating the insurance policy, may configure the terms of the insurance policy to the farmer's specific needs, such as tailoring the time period of coverage of the insurance policy to times of the year (such as designated month(s), designated season(s), etc.) at which the farmer may move the agricultural work machines and/or agricultural work assemblies on public roads.

Moreover, a singular natural event may, for example, be a hail storm or a heavy rain whose occurrence may be restricted to just a few days, such as a limited period within a year (e.g., 10 or fewer days within a designated year). Again, the insurance policy, drafted to insure against the natural event, may be tailored to a period of coverage for those few days.

Moreover, a location-related designation may be any one, any combination, or all of: a geographic specification of a field or several fields for crops; a business premises or a part of business premises; or roads between a field and the business premises and/or several fields. Using the location-related designation, the envisioned insurance coverage may be restricted to relevant areas on which the agricultural work machines and/or the agricultural work assemblies are moving. Relevant areas may be determined by, for example, the geo-referenced recording of traveled roads and work routes. In particular, one or both of the agricultural work machines and/or the agricultural work assemblies, may include sensors to generate the geo-referenced data in order to define the relevant areas. These relevant areas (e.g., any one, any combination, or all of places of business, field, and public and/or private roads) may be adapted, recorded or updated while entering the location-related designations with respect to their explicit selection, location and/or size. The location-related designation correspondingly may also be used in the context of the singular natural event (discussed above) whose occurrence may typically be limited to a defined area (such as locally). Accordingly, a location-related designation may be restricted to at least one specific field or specific region, in the area of which the occurrence of a singular natural event is expected. In this way, the insurance policy directed to the singular natural event may be defined to cover or be directed to the location-related designation, which may be tailored to the agricultural work machines and/or the agricultural work assemblies (such as based on data generated by sensors that indicate where the agricultural work machines and/or the agricultural work assemblies have traveled).

Moreover, a machine-specific designation may be the type of agricultural work machine and/or agricultural work assembly. Depending on the design, functioning and area of use of an agricultural work machine and/or and agricultural work assembly, one or more terms of an insurance policy may be automatically selected and automatically concluded, created, issued, or implemented based on the machine-specific designation in addition to a term restricted only with respect to time. Accordingly, for example, tractors are generally used as an agricultural work machine throughout the entire year; contrastingly, agricultural work machines such as combines, forage harvesters, balers or grubbers are frequently used only during shorter periods that may be a few days to several weeks, wherein these periods are dictated by the particular harvest times and are time-limited. As such, the system may generate one or more terms (such as the time periods) of the insurance policy based on the machine-specific designation. In particular, a data construct, such as a table, may correlate different machine-specific designations with corresponding time periods (e.g., tractor machine-specific designation correlated to a time period of the entire year; combine machine-specific designation correlated to a shorter time period limited to the particular harvest time).

Moreover, a plant-specific designation may comprise any one, any combination, or all of: the type of crop; the specific variety; or the available biomass. The automatic conclusion of a policy (performed by the system) may be limited by a plant-specific designation, for example to one or more fields that have a certain amount of biomass. Information on the presence of biomass and its quantification may be determined by suitable monitoring, for example by evaluating pictures that are created at intervals (e.g., constant cyclical intervals) by satellite or a drone. In particular, the pictures (e.g., digital images) may be analyzed, such as compared to one or more known pictures, in order to conclude as to the presence of biomass and/or its quantification. Likewise, data on the available biomass may be determined when planned fertilization tasks or plant protection tasks are performed during the crop cultivation process, for example using the administration system. While performing such a task, the crop may be recorded and evaluated (e.g., optically by a corresponding sensor device that may be arranged on the work machine and/or on the work assembly). This data may be transmitted to the administration system, which may serve the purpose of logging and evaluating the success of the performed tasks (e.g., a fertilization task or a plant protection task). In this regard, after issuance of the insurance policy, various sensors may be used to generate data, with the data being transmitted and analyzed to determine success or failure of the respective tasks. The crop type as a plant-specific designation may also be relevant with respect to its sowing and harvesting time since the impact of weather conditions on the particular crop may vary strongly within the periods between sowing and harvesting.

Moreover, a loss-type-specific designation may be a loss due to any one, any combination, or all of: weather influences; pest attack; wild animal influences; failure of the agricultural work machines and/or the work assemblies (e.g., a failure while driving in public street traffic and/or a technical failure during an agricultural work process or harvesting). A loss-type-specific designation enables a specific distinction between the loss types whose occurrence may, for example, vary strongly by region. For example, fields close to forests may be subject to greater wild animal influences than fields that, for example, are more distant from forests due to surrounding fields. Losses caused by weather influences may, for example, vary due to geographic conditions and the particularities of a region such as the proximity to mountains, rivers, etc. Failures of work machines and/or work assemblies while driving in public street traffic, such as from an accident, may be dependent on the existing infrastructure (e.g., the road network) that connects a business premises and one or more fields with each other, and the resulting traffic load. Likewise, a failure during an agricultural work process or harvesting of the work machine and/or work assembly may occur due to a technical defect, which is associated at least with delays in performing the agricultural work process or harvesting process. As such, the system, in configuring and implementing the insurance policy, may be a loss-type-specific designation. Again, the system may identify the particulars associated in implementing the loss-type-specific designation, such as the identified region of failure of the agricultural work machines and/or the work assemblies, via data input. These particulars may then be used to define one or more terms of the insurance policy, such as any one, any combination, or all of the action(s), the region(s), and/or the time period(s) of coverage by the insurance policy.

In particular, the actuarial information may be selected from any one, any combination, or all of: external influences; yield data; planning data; statistical data; cultivation information; geographic data; propensity to risk; or crop properties. External influences may comprise any one, any combination, or all of: weather influences; wild animal influences; or an unexpectedly high occurrence of pests (e.g., the number of which is unusually large due to a period of weather favorable to their development). The system may obtain the occurrence of weather influences using weather and climate information. In one or some embodiments, the weather and climate information may comprise shorter-term weather information as may be the case with hail, and/or longer-term climate information as may be the case in the prolonged absence of precipitation. The system may obtain information on weather influences from external data sources. Yield data may generally be saved in the at least one database of the administration system. The farmer may make corresponding records to, for example, be able to compare yields of previous years with each other. For this purpose, the machine assistance system may be configured to record and transmit data that are needed to determine the yield data. Among other things, this is so that the efficiency of undertaken tasks to increase yield (e.g., the quantitative use of fertilizers, pesticides, etc.) may be evaluated. Moreover, this information may constitute the basis of planning for the following year using the administration system. The planning data that include the schedule of the work processes constitute additional actuarial information. From this, the system may deduce, for example, when, where and/or how long the particular agricultural work machine and/or the agricultural work assembly was or will be used. Statistical data as actuarial information relate to the occurrence of events that, for example, have led at least to a partial loss of the crop in the past.

Statistical data as actuarial information may, however, also constitute the probability that an agricultural work machine and/or an agricultural work assembly has failed due to an event. This may include technical causes as well as accidents in public street traffic.

The risk propensity as actuarial information may constitute the readiness of the farmer to accept potential loss (e.g., the level of probable occurrence of a loss event to be insured that leads to the automatic conclusion or implementation (such as the insurance policy payout) of the policy by the machine assistance system).

In one or some embodiments, the server platform may have an input/output unit that is configured to receive any one or both of: the at least one specific designation for a unit to be insured; or third-party offer data for a policy for a unit to be insured. The server platform may further include an evaluation unit that is configured to evaluate the at least one specific designation and/or the actuarial information, and the evaluation unit is configured to compare the evaluation with the third party offer data to select an optimized policy offer. The server platform may enable comprehensive communication between the machine assistance system and third parties to obtain or adjust offers for a policy based upon the designations by the farmer and the provided actuarial information.

In particular, the machine assistance system may be configured to automatically trigger the conclusion of the selected policy (e.g., the consummation, creation, or issuance of the contract for the insurance policy) depending on at least one specifiable risk threshold (e.g., depending on receipt of the at least one specifiable risk threshold). The risk threshold may be the probability of occurrence of a loss event, and/or a risk propensity on the part of the policyholder, or respectively farmer to be quantified. The designation of at least one risk threshold by the farmer as the policyholder may determine the conditions under which an insurance policy should be automatically concluded, created, or issued (e.g., the act that triggers the creation of the contract by which the insurance policy goes into effect). The probability of occurrence of a loss event may also be obtained from models such as meteorological models, and/or from historical data material based on years of observations in the different regions in which for example a weather-related loss event has repeatedly occurred. The risk propensity is contrastingly a decision on the part of the policyholder. The risk threshold may be determined in the context of preliminary planning by an automatic query, for example by the machine assistance system, the input/output unit of the server platform, or another input interface of the administration system that is intended for the policyholder, such as the farmer. It is however also contemplated to use designations of a risk threshold made in the past, and their validity may be confirmed in the context of a query. In this regard, in one or some embodiments, the risk threshold may be determined without any contemporaneous input from the policyholder as to the risk threshold.

Moreover, the machine assistance system may be configured to transmit a manually or automatically recorded loss event to the server platform. In the instance of an automatically recorded loss event, the machine assistance system may be configured to: (i) automatically determine whether the loss event has occurred based on analysis of data (discussed below); and (ii) responsive to determining the loss event has occurred, automatically transmit an indication of the loss event to the server platform. In particular, automated recording and transmission of a loss event is advantageous, such as to streamline administrative processes. In the case of a loss event that arises from weather damage, a comparative analysis may be performed of the biomass on a relevant field that was recorded for example with pictures before and after the loss event by satellite or using a drone. For example, the machine assistance system may periodically analyze pictures of a field at different times (e.g., at a predetermined time periods), such as pictures taken daily, weekly, monthly, etc. such that a first picture that is taken most recently is automatically compared with a picture taken in the previous time period. Responsive to the machine assistance system automatically determining, based on the comparison, that the loss event has occurred, the machine assistance system may automatically transmit to the server platform. It is also contemplated for an agricultural work machine as an insured unit to independently transmit a loss report to the server platform using the machine assistance system. In particular, in one or some embodiments, the agricultural work machine may perform the automatic determination and/or may automatically generate the data used to determine the loss event. Responsive to the automatic determination and/or the automatic generating of the data used to make the determination of the loss event, the agricultural work machine may transmit to the machine assistance system the automatic determination and/or the data used by the machine assistance system to perform the determination. In so doing, the machine assistance system may receive from an additional control device of the agricultural work machine and/or the work assembly additional operating data from the work machine or the work assembly such as servicing data, repair data, GPS data, etc., and automatically transmit it to the server platform which enables simplification in the determination of value (e.g., the amount to pay under the insurance policy).

In one or some embodiments, the machine assistance system may be part of an agricultural work machine and/or an agricultural work assembly. In this case, the machine assistance system may be configured to communicate with a portable data processing device. A portable data processing device may be a cell phone, such as a smartphone, a laptop or a tablet computer.

Moreover, the machine assistance system may be configured to independently query specific designations, determine specification parameters and criteria using the query results, and automatically transmit them to the server platform. In particular when the machine assistance system is part of the agricultural work machine and the machine assistance system is configured to communicate with the portable data processing device, the designations may be entered by the farmer or another authorized operator using the portable data processing device and transmitted to the machine assistance system. In this way, it may be advantageous to have the machine assistance system to be associated with (e.g., be a part of) the agricultural work machine in order to aid in transmitting the one or more designations on the machine that is central to the insurance policy.

In particular, the machine assistance system may be configured to independently and/or automatically request one or more risk thresholds and automatically transmit them to the server platform. The request may repeat cyclically. Depending on the properties of the unit to be insured, this request may be, for example, repeated every year or only when there is a change to the unit to be insured. A change to a property of the unit to be insured may, inter alia, be a change to the field size, a new field, a change to the crop rotation and/or the crop type, an exchange of the work machine and/or a work assembly. In this way, associating the machine assistance system with the agricultural work machine may be beneficial to obtaining the changes to a property of the unit to be insured and/or to the machine itself. Moreover, changed requirements (e.g., of the risk propensity or maximum level of the insurance premium) may thereby be considered as a cost factor for the farmer. In this regard, the system may perform one or more of the various stages of the insurance policy, including any one, any combination, or all of: triggering to begin the process of creating the insurance policy; obtaining information in order to assess terms for the insurance policy; concluding, creating or issuing the insurance policy (e.g., the act by which the insurance policy goes into effect); or implementation of the insurance policy (e.g., the acts to determine whether to payout under the terms of the insurance policy and/or the actual act of paying out under the terms of the insurance policy).

In one or some embodiments, a method is disclosed for operating a computer-assisted agricultural administration system performing any one, any combination, or all of the actions discussed herein.

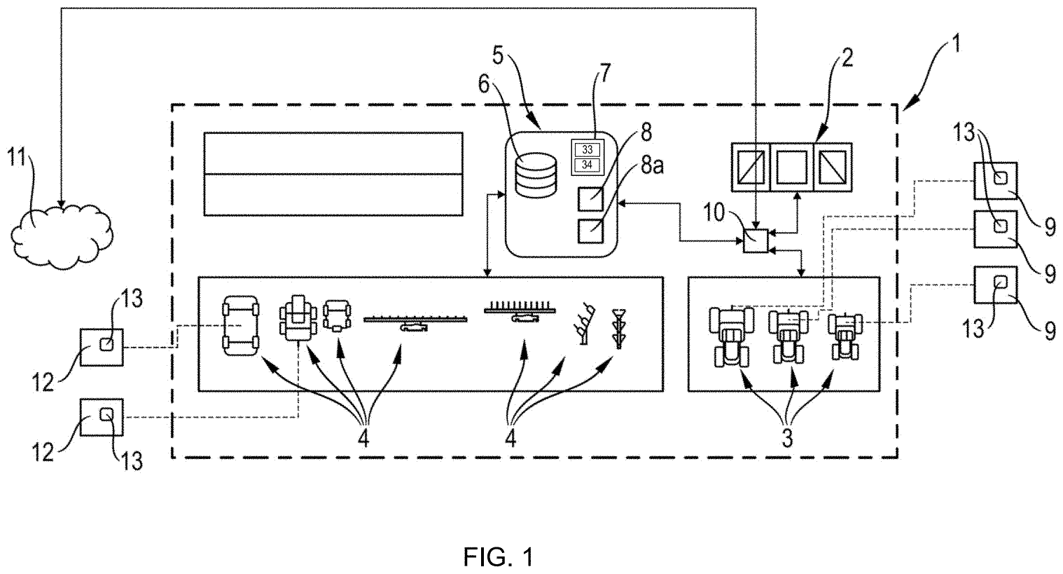

Referring to the figures, FIG. 1 illustrates a computer-assisted agricultural administration system with a schematic and exemplary overview of a business premises 1 such as a farmyard. Warehouses 2, various agricultural work machines 3 and different agricultural work assemblies 4 are on the business premises 1. The agricultural work machines 3 may, for example, be tractors and/or self-propelling harvesters. Alternatively, or in addition, the agricultural work assemblies 4 may, for example, be attachments or mounted units for the tractors, attachments for the harvesters, balers, loading vehicles with a gathering device for harvested material, transport trucks, etc.

The administration system includes a server platform 5 with at least one database 6, a computing unit 7, an input/output unit 8, an evaluation unit 8a, and at least one interface 10 for bidirectional communication with at least one external data source 11.

Computing unit may comprise at least one processor and at least one memory, which is depicted in FIG. 1 as processor 33 (which may comprise a microprocessor, controller, PLA, or the like) and memory 34. Though the processor 33 and memory 34 are depicted as separate elements, they may be part of a single machine, which includes a microprocessor (or other type of controller) and a memory.

The processor 33 and memory 34 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

A machine assistance system 9 is assigned to the agricultural work machines 3, wherein the machine assistance system 9 may be part of the agricultural work machines 3. The machine assistance system 9 is configured to control or regulate components of the agricultural work machine 3 such as a drive device, chassis, steering system, transfer system and/or lane guidance system, as well as devices for processing and handling harvested material.

Alternatively, or in addition, a machine assistance system 12 may be assigned to the agricultural work assemblies 4 that is configured to control or regulate components of the agricultural work assembly 4. In one or some embodiments, the machine assistance system 12 may be part of the agricultural work assembly 4. The machine assistance systems 9 and 12 may communicate with each other by a bus system in order to exchange data needed to control or regulate. The bus system may be designed as wired or wireless. Similar to computing unit 7, the machine assistance system 9, 12 may include at least one processor and at least one memory (not shown).

Moreover, the machine assistance systems 9 and 12 may also provide additional operating data such as service data, repair data and GPS data to the agricultural work machines 3 and/or the work assemblies 4. This additional operating data may also be provided by an additional control device of the agricultural work machine 3 and/or the agricultural work assembly 4 and transmitted to the machine assistance systems 9 and/or 12.

Each machine assistance system 9, 12 has an input/output unit 13 through which an operator of the agricultural work machine 3 and/or the agricultural work assembly 4 may interact with the particular machine assistance system 9, 12. The input/output unit 13 may be located on the agricultural work machine 3 or on the agricultural work assembly 4. A mobile design of the input/output unit 13 is also contemplated as a portable data processing apparatus such as a cell phone, a tablet, etc. that is configured to execute application software and communicate with the particular machine assistance system 9, 12.

Moreover, the agricultural work machines 3 and/or the work assemblies 4 (not shown) include sensor apparatuses that serve to record data in order to log work and operating processes. Work and operating processes include activities executed by the agricultural work machines 3 and/or the work assemblies 4 that are associated with the execution and performance of agricultural processes. The sensor apparatuses may, for example, serve to record the amount of spread seed, manure, etc. Likewise, a suitable sensor apparatus may record the yield and map the yield of harvested crop. This data may be automatically transmitted via the at least one interface 10 to the server platform 5 of the administration system. The transmission from the machine assistance systems 9 and/or 12 to the server platform 5 may generally occur cyclically in order to continuously update the saved database of the at least one database 6.

External data sources 11 may be data sources that are located outside of the business premises 1 or may be independent of the agricultural work machine 3 and work assemblies 4. An external data source 11 may, for example, be a GPS satellite, a weather station, the Internet, a computer center, etc.

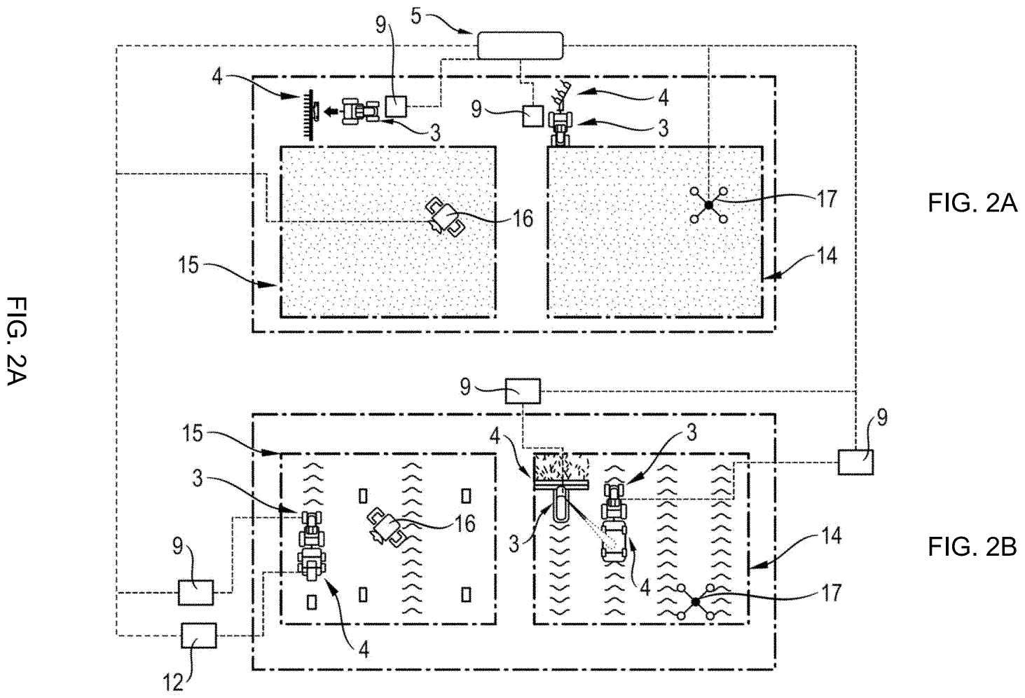

FIGS. 2a-2b illustrate a schematic and exemplary representation of two fields 14, 15 at different processing times. On the right side of FIG. 2a, FIG. 2a shows a field 14 that, for example, is processed by an agricultural work machine 3 designed as a tractor with a plow as the agricultural work assembly 4. On the left side, FIG. 2a shows another field 15 that, for example, is processed by an agricultural work machine 3 designed as a tractor with a disc harrow as the agricultural work assembly 4.

On the right side of FIG. 2b, FIG. 2b shows a field 14 at the time of harvest that, for example, is processed by an agricultural work machine 3 designed as a forage harvester with an attachment as the agricultural work assembly 4. On the left side of FIG. 2b, FIG. 2b shows the field 15 after haymaking that, for example, is processed by an agricultural work machine 3 designed as a tractor with a baler as the agricultural work assembly 4.

As shown merely as examples in FIGS. 2a and 2b, the fields 14, 15 may, for example, be monitored by a satellite 16 or a drone 17. In this manner, data may be regularly or periodically collected on the status of the particular field 14, 15 and the development of the crop cultivated thereupon, and transmitted to the server platform 5 of the administration system for evaluation and logging. The data provided by the satellite 16 or the drones 17 may be supplemented with the data generated by the sensor apparatus or the sensor apparatuses of the agricultural work machines 3 and/or the work assemblies 4.

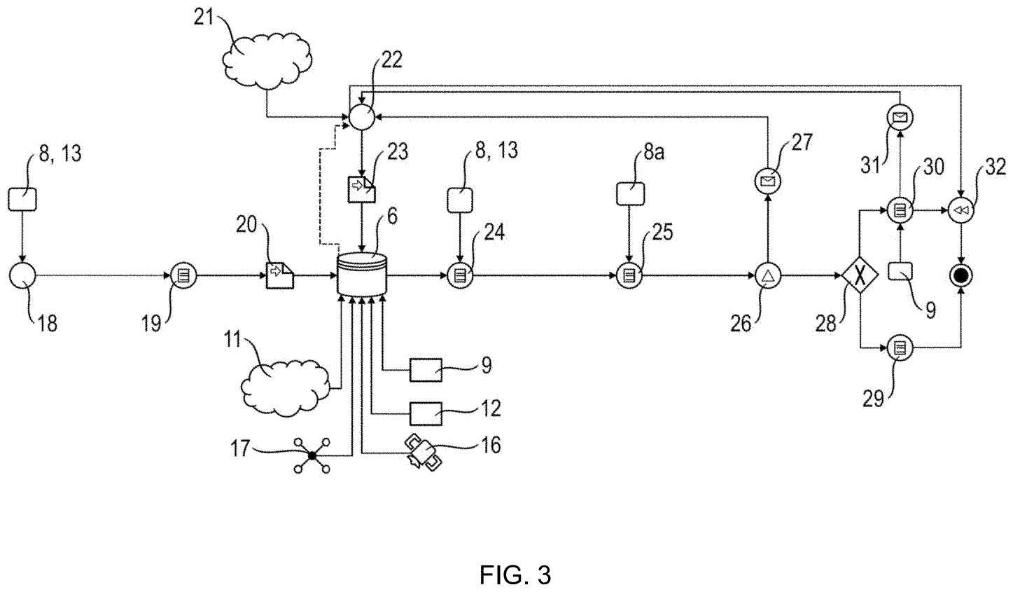

FIG. 3 shows a flowchart of the method for operating the disclosed administration system. In the context of planning for the execution and performance of agricultural processes using the administration system, it may be warranted to guard against risks that, for example, may result from unmanageable natural events or other external influences, such as those involving third parties. Thus, in one or some embodiments, the invention may therefore be based on the underlying concept of automatically specifically guarding against singular risks when performing agricultural processes. The at least one specific designation of a unit to be insured may specifically limit the envisioned insurance coverage.

In one or some embodiments, the machine assistance system 9, 12 is configured to automatically conclude, create or issue at least one insurance policy via the server platform 5 depending on (and optionally responsive to) an entry of at least one specific designation of a unit to be insured via the input/output unit 13 of the machine assistance system 9, 12. To accomplish this, the policyholder may specify and designate risks to be insured as a designation using the input/output unit 8, the server platform 5 or an input/output unit 13 of one of the machine assistance systems 9, 12 in step 18. A risk to be insured as a specific designation to be entered may, for example, be hail insurance, crop failure insurance or liability insurance for one of the agricultural work machines 3. The risk to be insured as a specific designation to be entered may, for example, be entered using a structured query. For example, the farmer may enter the specific designation via a graphical user interface (GUI) or the like.

In the following step 19, a selection of specification parameters and criteria is made using the at least one specific designation. To accomplish this, the at least one specific designation may be selected from any one, any combination, or all of: time-related; location-related; machine-specific; plant-specific; or loss-type-specific designations. A time-related designation may comprise a limit of the policy term to a period of a loss event to be expected that is determined based on actuarial information.

A location-related designation may comprise any one, any combination, or all of: a geographic specification of the position of a field 14, 15 that includes crop; the business premises 1 or part of the business premises 1; or routes between the field 14, 15 and the business premises 1. The business premises 1, its parts, as well as the fields 14, 15 that include crop may each form a unit to be insured.

The machine-specific designation may comprise the type of agricultural work machine 3 and/or an agricultural work assembly 4. The agricultural work machines 3 and the agricultural work assemblies 4 may each form a unit to be insured.

A plant-specific designation may comprise any one, any combination, or all of: the type of crop; the specific variety; or the available biomass. The plant-specific designation may include the particular cultivation information of a specific field 14, 15. A loss-type-specific designation may comprise damage arising or resulting from any one, any combination, or all of: weather influences; pest attack; wild animal influences; or a failure of agricultural work machines 3 and/or agricultural work assemblies 4 (e.g., while driving in public street traffic (such as due to an accident) and/or due to a technical failure). The above-listed designations may be selectable individually or in any combination with each other from the group of time-related, and/or location-related, and/or machine-specific, and/or plant-specific, and/or loss-type-specific designations. This selection enables the policyholder (e.g., the farmer as the operator of the agricultural business premises 1, or as the operator of an agricultural work machine 3 and/or an agricultural work assembly 4) to specify the framework, in a flexible and specifically adapted manner, for which an insurance policy may be automatically concluded, consummated, or issued.

In step 20, the at least one entered specific designation is transmitted to the server platform 5 and saved in the at least one database 6. Thus, in one or some embodiments, all of the designations are manually input. Alternatively, none, one, some, or each of the designations are manually input, and a remaining (e.g., none, one, some, or all) designations are automatically determined

In step 22, one or more insurers 21 may specify their range of services (e.g., which risks are insured under which conditions) and/or specific selection criteria for the selection of policyholders. The particular range of services and the associated selection criteria of the insurer(s) 21 may be transmitted in step 23 to the server platform 5 and saved in the at least one database 6. Steps 22 and 23 may be iteratively performed, such as repeated continuously, in order to update the range of services and associated selection criteria.

In step 24, the input/output unit 8, 13, the server platform 5 or one of the machine assistance system 9, 12 may perform an automatically initiated query with respect to a selection of any one, any combination, or all of the designations that were entered in the preceding steps in 18 and 19. Moreover, at least one risk threshold may be queried in step 24. The risk threshold may be the probability of occurrence of a specific loss event, and/or a risk propensity on the part of the policyholder, or respectively farmer to be quantified. The probability of occurrence of a loss event may also be obtained from models such as meteorological models, and/or from historical data material based on years of observations in the different regions in which, for example, a weather-related loss event has repeatedly occurred. Alternatively, or in addition, it is contemplated to use designations of a risk threshold made in the past, and their validity may be confirmed in the context of this query.

The query in step 24 enables the assigning of different risk thresholds to the different specific designations for a unit to be insured, with the different designations selected from any one, any combination, or all of: time-related designation(s); location-related designation(s); machine-specific designation(s); plant-specific designation(s); or loss-type-specific designation(s). The designation of a risk threshold may determine the conditions under which a policy may be automatically concluded (e.g., the conditions under which a payout results). Moreover, information on an available budget may be provided in step 24.

In step 25, the evaluation unit 8a of the server platform 5 compares the entries entered in step 24 with one or both of the range of services transmitted to the server platform 5 in step 23 and the associated selection criteria of the insurer(s) 21 in order to select a suitable insurance policy corresponding to the at least one specific designation for a unit to be insured.

In step 26, the machine assistance system 9, 12 automatically concludes or ends an insurance policy if the at least one risk threshold is reached or exceeded. To accomplish this, the computing unit 7 of the server platform 5 accesses the data saved in a database 6 (e.g., the data comprising any one, any combination, or all of: the entered designations from the policyholder; the information from the insurers 21; and the available actuarial information from the external data source 11) in order to determine whether the at least one risk threshold has been reached or exceeded. The automation of the conclusion by the machine assistance system 9, 12 leads to a simplification of achieving and optimizing insurance coverage. Insurance coverage is concluded in the context of the at least one specific designation of an insured unit, wherein the insurance coverage is concluded in particular with respect to the specific time, location and/or device.

In step 27, the contractual data needed for the conclusion, creation, or issuance of the insurance policy is automatically transmitted to the insurer 21.

Step 28 identifies the server platform 5 evaluating an occurrence of a loss event. In the event that there is no insured loss event, there is a branching to step 29. If, in contrast, an insured loss event exists, there is a transition to step 30.

In step 30, data relevant to the loss event is automatically determined and saved in a database 6 of the server platform 5. The data relevant to the loss event may, for example, include data on any one, any combination, or all of: the extent of the loss; the type of loss; and the location of the loss. The data on the extent of the loss may, for example, be determined by the satellite 16 or the drone 17 when one of the fields 14, 15 has been affected by a crop failure. In this case, before and after pictures (e.g., pictures of the biomass of the relevant field 14, 15 using recent images before and after the loss event) may be compared. Alternatively, or in addition, a suitable sensor apparatus of the agricultural work machine 3 and/or the agricultural work assembly 4 may record the data relevant to a loss event. The relevant data may be read out of the database 6 by the machine assistance system 9, 12 and transmitted in step 31 to the relevant insurance company for reporting and subsequent claims processing. Alternatively, or in addition, the server platform 5 may transmit the recorded data on the loss event to the insurer 21.

If the loss event, for example, relates to one of the agricultural work machines 3, the machine assistance system 9 of the relevant agricultural work machine 3 may transmit data relevant to the loss event to the insurer 21. The agricultural work machine 3 may, for example, transmit any one, any combination, or all of operating data, the service status, repair data, etc., which may assist in value determination (e.g., the value of the loss). Further, GPS data on the work machine may provide information on the current location of the agricultural work machine 3.

The claim settlement may then be concluded in step 32 (e.g., the payout may be automatically issued).

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

List of Reference Numbers

| | | | |
|---|---|---|---|
| 1 | Business premises | 24 | Step |
| 2 | Warehouse | 25 | Step |
| 3 | Work machine | 26 | Step |
| 4 | Work assembly | 27 | Step |
| 5 | Server platform | 28 | Step |
| 6 | Database | 29 | Step |
| 7 | Computing unit | 30 | Step |
| 8 | Input/output unit | 31 | Step |
| 8a | Evaluation unit | 32 | Step |
| 9 | Machine assistance system | 33 | Processor |
| 10 | Interface | 34 | Memory |
| 11 | External data source | | |
| 12 | Machine assistance system | | |
| 13 | Input/output unit | | |
| 14 | Field | | |
| 15 | Field | | |
| 16 | Satellite | | |
| 17 | Drone | | |
| 18 | Step | | |
| 19 | Step | | |
| 20 | Step | | |
| 21 | Insurer | | |
| 22 | Step | | |
| 23 | Step | | |

1. A computer-assisted agricultural administration system configured for planning, monitoring and administering work and operating data in execution and performance of agricultural processes, the computer-assisted agricultural administration system comprising:
a server platform including at least one database and at least one interface for bidirectional communication with at least one external data source, wherein the at least one database is configured to store data related to at least one of planning, monitoring and administering agricultural processes; and
a machine assistance system including an input/output unit, wherein the machine assistance system is configured to:
receive, via the input/output unit, at least one specific designation;
automatically determine a probability of occurrence of a loss event to be insured; and
automatically select, based on the at least one specific designation, the data related to at least one of planning, monitoring and administering agricultural processes, the probability of occurrence of the loss event, and actuarial information, one or more terms of an insurance policy, in order to automatically issue the insurance policy.

2. The computer-assisted agricultural administration system of claim 1, wherein the at least one specific designation comprises one or more of a time-related designation, a location-related designation, a machine-specific designation, a plant-specific designation, or a loss-type-specific designation.

3. The computer-assisted agricultural administration system of claim 2, wherein the machine assistance system is configured to receive the actuarial information from at least one external data source;
wherein the at least one specific designation comprises the time-related designation; and
wherein the machine assistance system is configured to select, based on the actuarial information, a policy term of the insurance policy based on the time-related designation, the time-related designation being determined based on the actuarial information.

4. The computer-assisted agricultural administration system of claim 3, wherein the at least one specific designation further comprises a location-related designation;
wherein the location-related designation comprises one or more of a geographic specification of a position of one or more crops, part or all of a business premises, or routes between the one or more crops and the business premises; and
wherein the machine assistance system is configured to select, based on the location-related designation, a defined area for the insurance policy.

5. The computer-assisted agricultural administration system of claim 2, wherein the at least one specific designation comprises a machine-specific designation;
wherein the machine-specific designation comprises one or both of a type of an agricultural work machine or a type of an agricultural work assembly; and
wherein the machine assistance system is configured to select, based on the machine-specific designation, the one or more terms of the insurance policy.

6. The computer-assisted agricultural administration system of claim 2, wherein the at least one specific designation comprises a plant-specific designation;
wherein the plant-specific designation comprises one or more of a type of crop, a specific variety, or available biomass; and
wherein the machine assistance system is configured to select, based on the plant-specific designation, a policy term of the insurance policy of the insurance policy or a task insured under the insurance policy.

7. The computer-assisted agricultural administration system of claim 2, wherein the at least one specific designation comprises a loss-type-specific designation; and
wherein the loss-type-specific designation comprises a loss due to one or more of weather influences, pest attack, wild animal influences, a failure of one or both of work machines or work assemblies while driving in public street traffic, or a technical failure of the one or both of work machines or work assemblies during an agricultural work process.

8. The computer-assisted agricultural administration system of claim 1, wherein the actuarial information comprises one or more of external influences, yield data, planning data, statistical data, cultivation information, geographic data, propensity to risk or crop properties.

9. The computer-assisted agricultural administration system of claim 1, wherein the server platform includes:
an input/output unit configured to receive the at least one specific designation and third-party offer data for a policy for a unit to be insured; and
an evaluation unit configured to:
evaluate the at least one specific designation and the actuarial information; and
compare the evaluation with the third-party offer data in order to select an optimized policy offer.

10. The computer-assisted agricultural administration system of claim 1, wherein the one or more terms of the insurance policy comprise at least one specifiable risk threshold indicative of a condition under which to pay a claim; and
wherein the machine assistance system is further configured to:
automatically determine whether the at least one specifiable risk threshold has been met; and
responsive automatically determining that the at least one specifiable risk threshold has been met, automatically send one or more communications in order to cause payment of the claim.

11. The computer-assisted agricultural administration system of claim 10, wherein the machine assistance system is configured to transmit a manually or automatically recorded loss event to the server platform.

12. The computer-assisted agricultural administration system of claim 1, wherein the agricultural process is performed by one or both of an agricultural work machine an agricultural work assembly; and
wherein the machine assistance system is part of the one or both of the agricultural work machine or an agricultural work assembly.

13. The computer-assisted agricultural administration system of claim 1, wherein the machine assistance system is configured to:
independently query specific designations in order to obtain query results;
determine, using the query results, specification parameters and criteria; and
automatically transmit the specification parameters and the criteria to the server platform.

14. The computer-assisted agricultural administration system of claim 1, wherein the machine assistance system is configured to:
independently request one or more risk thresholds; and
automatically transmit the one or more risk thresholds to the server platform.

15. A method for operating a computer-assisted agricultural administration system, the method comprising:
using a server platform that includes at least one database and at least one interface for bidirectional communication with at least one external data source, wherein the at least one database is configured to store data related to at least one of planning, monitoring and administering agricultural processes;
receive, via an input/output unit of a machine assistance system, at least one specific designation;
automatically determine, by the machine assistance system, a probability of occurrence of a loss event to be insured; and
automatically select, by the machine assistance system and based on the at least one specific designation, the data related to at least one of planning, monitoring and administering agricultural processes, the probability of occurrence of the loss event, and actuarial information, one or more terms of an insurance policy, in order to automatically issue the insurance policy.

16. The method of claim 15, wherein the at least one specific designation comprises one or more of a time-related designation, a location-related designation, a machine-specific designation, a plant-specific designation, or a loss-type-specific designation.

17. The method of claim 16, wherein the machine assistance system receives the actuarial information from at least one external data source;
wherein the at least one specific designation comprises the time-related designation; and
wherein the machine assistance system selects, based on the actuarial information, a policy term of the insurance policy based on the time-related designation, the time-related designation being determined based on the actuarial information.

18. The method of claim 17, wherein the at least one specific designation further comprises a location-related designation;
wherein the location-related designation comprises one or more of a geographic specification of a position of one or more crops, part or all of a business premises, or routes between the one or more crops and the business premises; and
wherein the machine assistance system selects, based on the location-related designation, a defined area for the insurance policy.

19. The method of claim 16, wherein the at least one specific designation comprises a machine-specific designation;
wherein the machine-specific designation comprises one or both of a type of an agricultural work machine or a type of an agricultural work assembly; and
wherein the machine assistance system selects, based on the machine-specific designation, the one or more terms of the insurance policy.

20. The method of claim 16, wherein the at least one specific designation comprises a plant-specific designation;
wherein the plant-specific designation comprises one or more of a type of crop, a specific variety, or available biomass; and
wherein the machine assistance system selects, based on the plant-specific designation, a policy term of the insurance policy of the insurance policy or a task insured under the insurance policy.
